(19) United States
(12) Patent Application Publication
(10) Pub. No.: US 2017/0090146 A1
(43) Pub. Date: Mar. 30, 2017

(54) LENS DRIVE DEVICE

(71) Applicant: ALPS ELECTRIC CO., LTD., Tokyo (JP)

(72) Inventor: Katsuyuki Ishiguro, Miyagi-ken (JP)

(21) Appl. No.: 15/270,496

(22) Filed: Sep. 20, 2016

(30) Foreign Application Priority Data
Sep. 29, 2015 (JP) 2015-191117

(51) Int. Cl. G02B 7/08; G02B 27/64

(52) U.S. Cl. CPC G02B 7/08; G02B 27/646

(57) ABSTRACT

A lens holder is movably supported by plate springs in a support member provided in a movable unit. Legs of the support member have X direction positioning portions and Y direction positioning portions. Inner facing surfaces of some magnets are in contact with the X direction positioning portions so as to be positioned, and inner facing surfaces of other magnets are in contact with the Y direction positioning portions so as to be positioned. This allows a facing distance to be set without being affected by a variation in thickness among the magnets.

### CLAIM OF PRIORITY

This application claims benefit of priority to Japanese Patent Application No. 2015-191117 filed on Sep. 29, 2015, which is hereby incorporated by reference in its entirety.

### BACKGROUND

1. Field of the Disclosure

The present disclosure relates to a lens drive device in which a lens holder is supported by a support member such that the lens holder is movable in the optical axis direction relative to the support member. In particular, the present disclosure relates to a lens drive device that allows a facing distance between an axial drive coil provided in the lens holder and a magnet secured to the support member to be highly accurately determined.

2. Description of the Related Art

Japanese Unexamined Patent Application Publication No. 2013-24938 describes an arrangement relating to a lens drive device.

In the lens drive device described in Japanese Unexamined Patent Application Publication No. 2013-24938, four suspension wires are secured to a base, and an autofocus (AF) unit is supported by distal end portions of the suspension wires.

The AF unit is provided with a lens holder inside a magnet holder. A lens is disposed in the lens holder. An upper plate spring is secured to an upper end of the magnet holder. An upper end portion of the lens holder is supported by the upper plate spring. A lower plate spring is secured to a lower end of the magnet holder. A lower end portion of the lens holder is supported by the lower plate spring. Upper end portions of the suspension wires are secured to the plate spring.

A focus coil is provided in the lens holder and permanent magnets are secured to the magnet holder in the AF unit. The lens holder is driven in the optical axis direction in this AF unit due to a current flowing through the focus coil. Furthermore, a camera-shake compensation coil that faces lower end surfaces of the permanent magnets is provided in the base. The AF unit supported by the suspension wires is moved in a direction perpendicular to the optical axis due to a current flowing through the camera-shake compensation coil. Thus, camera shake is compensated.

In a lens actuator described in Japanese Unexamined Patent Application Publication No. 2013-127492, similarly to the lens drive device described in Japanese Unexamined Patent Application Publication No. 2013-24938, a movable unit is supported by suspension wires such that the movable unit is movable in a direction intersecting the optical axis. In the movable unit, a lens holder is supported by a plate spring inside a magnet holder such that the lens holder is movable in the optical axis direction.

First coils are provided in the lens holder, second coils are provided in a base, and magnets that face the coils are provided in the magnet holder. The lens holder is driven in the optical axis direction due to currents flowing through the first coils. The movable unit is driven in a direction intersecting the optical axis due to currents flowing through the second coils.

In the lens drive device (lens actuator) described in Japanese Unexamined Patent Application Publication Nos. 2013-24938 and 2013-127492, requires that facing distance between each of the plurality of magnets secured to the magnet holder and the focus coil (first coils) be made uniform as much as possible. When the distance between the plurality of magnets and the focus coil varies from magnet to magnet in a single lens drive device, a drive force to drive the lens holder in the optical axis direction becomes non-uniform among portions that face the magnets. Thus, it is impossible to stabilize the orientation of the lens holder while driving the lens holder in the optical axis direction.

The variation in distance between the magnets and the focus coil also leads to the difference in drive force in the axial direction among the lens drive devices when a specified control current is applied to the focus coil, and accordingly, dynamic sensitivity in focusing varies among the products.

According to a technique described in Japanese Unexamined Patent Application Publication No. 2013-24938, rear surfaces of the permanent magnets opposite to surfaces facing the focus coil are in contact with the magnet holder so as to position the permanent magnets. With this structure, a variation in thickness among the permanent magnets directly causes a variation in facing distance between the focus coil and the permanent magnets. Thus, it is required that a tolerance of thickness of the permanent magnets be very finely controlled. Accordingly, it is unavoidable that the manufacturing cost of the permanent magnets is increased.

According to a technique described in Japanese Unexamined Patent Application Publication No. 2013-127492, the magnets are secured in openings formed in wall portions of the magnet holder. However, a structure for positioning the magnets in a direction facing the first coils is not provided. Thus, it is difficult to accurately control the distances between the magnets and the first coils.

The present invention provides a lens drive device that can be assembled while highly accurately controlling a facing distance between a magnet and an axial drive coil that drives a lens holder in the optical axis direction.

### SUMMARY

According to an aspect of the present invention, a lens drive device includes a support member, a lens holder, a plate spring, and an axial-direction drive mechanism. The lens holder is configured such that it allows a lens body to be disposed therein. The plate spring is provided so as to connect the support member and the lens holder to each other and supports the lens holder such that the lens holder is movable in an optical axis direction. The axial-direction drive mechanism moves the lens holder relative to the support member in the optical axis direction. The axial-direction drive mechanism includes an axial drive coil and a magnet. The axial drive coil is supported by the lens holder and wound so as to surround the lens holder. The magnet is secured to the support member and faces the axial drive coil. The support member includes at least one positioning portion that is in contact with an inner facing portion of the magnet facing a lens holder side so as to position the magnet.

### BRIEF DESCRIPTION OF THE DRAWINGS

FIG. 1 is a perspective view of a lens drive device according to an embodiment of the present invention seen from above;

FIG. 2 is a perspective view of the lens drive device of FIG. 1 with a cover removed;

FIG. 3 is an exploded perspective view of the lens drive device with the cover removed, separately illustrating main parts of the lens drive device;

FIG. 4 is an exploded perspective view of a support member and magnets secured to the support member seen from below;

FIG. 5 is a sectional plan view of part of the lens drive device of FIG. 2 taken along line V-V;

FIG. 6 is a longitudinal sectional view of the lens drive device of FIG. 5 taken along line VI-VI;

FIG. 7 is a plan view illustrating positional relationship between the support member and a lens holder;

FIG. 8 is an enlarged exploded perspective view illustrating part of the relationship between the support member and a plate spring; and

FIG. 9 is a longitudinal sectional view of the lens drive device taken along line IX-IX of FIG. 7.

### DESCRIPTION OF THE EXEMPLARY EMBODIMENTS

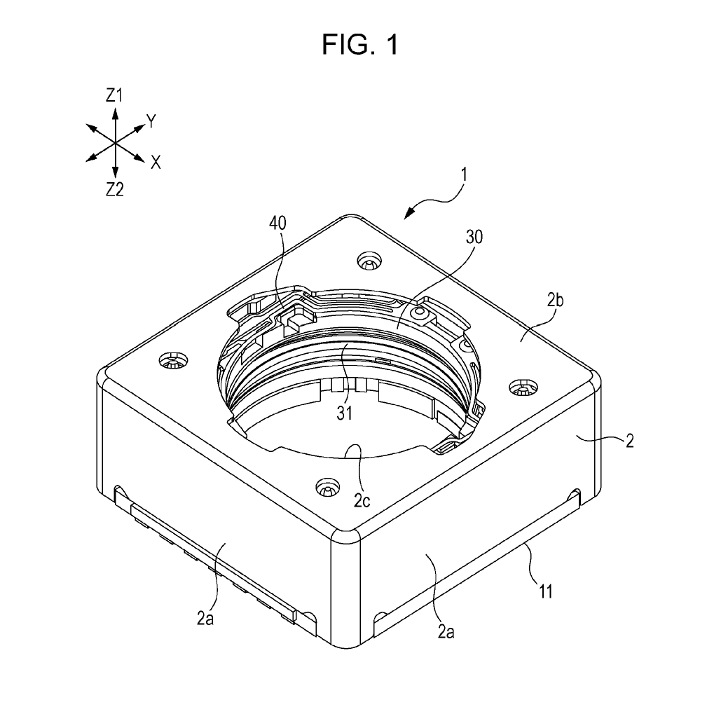

A lens drive device 1 of FIG. 1 is, together with an imaging device, disposed in a mobile phone, a mobile information terminal, or the like. Although omitted in the following embodiment, a lens body (lens barrel) that faces the imaging device can be disposed in a lens holder 30 of the lens drive device 1. The lens holder 30 is driven in the optical axis direction of the lens body so as to perform automatic focus adjustment. Also, the lens holder 30 is driven in directions intersecting the optical axis so as to compensate for camera shake.

It is noted that, in each of the drawings, a Z1 direction is an upper side of the lens drive device 1 and a Z2 direction is a lower side of the lens drive device 1. The Z1 direction extends toward a front side where a subject to be picked up with the imaging device exists. The Z2 direction extends toward a rear side where the imaging device exists.

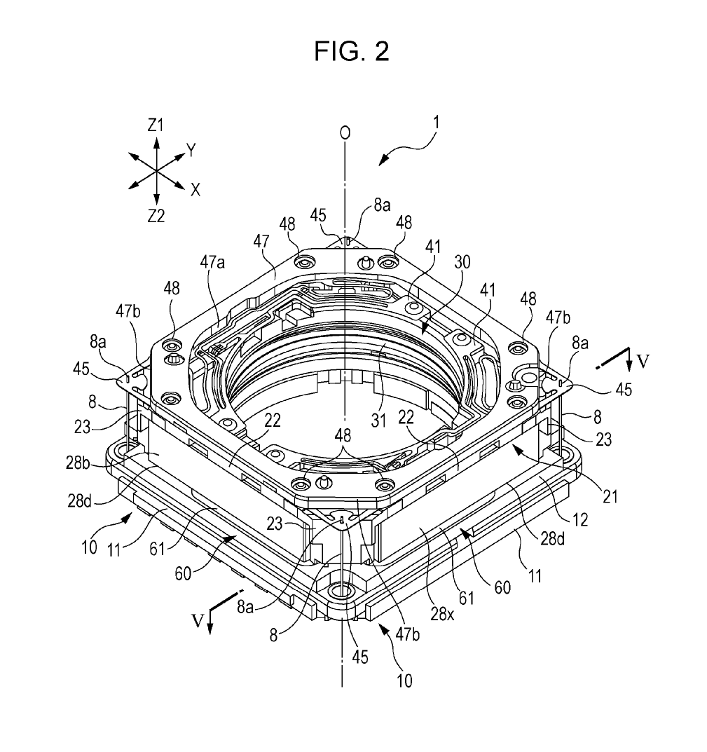

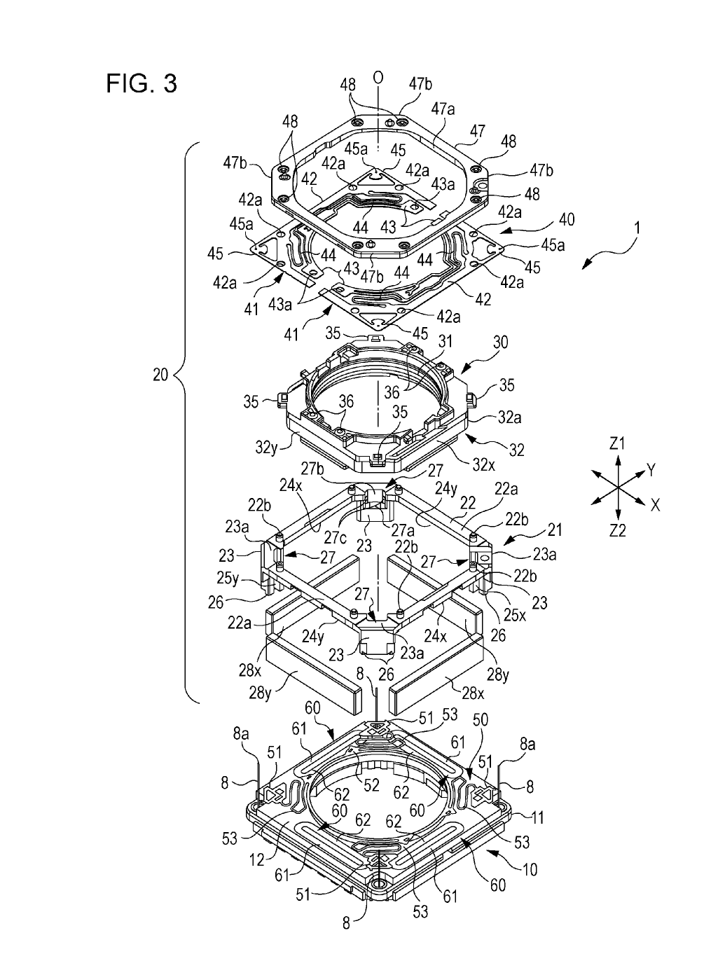

FIG. 1 illustrates an overall structure of the lens drive device 1, FIG. 2 illustrates the lens drive device 1 with a cover 2 removed, and FIG. 3 is an exploded view of the lens drive device 1, separately illustrating main parts of the lens drive device 1. A center line O of the lens drive device 1 is indicated in the drawings. When the lens body is disposed in the lens drive device 1, the center line O is coincident with the optical axis of the lens body (lens).

As illustrated in FIG. 3, the lens drive device 1 includes a base structure 10. The base structure 10 includes a base 11 formed of synthetic resin. A metal base, which is formed of metal and divided into a plurality of pieces, is embedded in the base 11. The metal base and the base 11 are integrally formed by so-called insert molding. Proximal ends (lower ends) of four suspension wires 8 are secured to the metal base. Preferably, upper ends 8a of the suspension wires 8 support a movable unit 20 so as to allow the movable unit 20 to move in directions intersecting (perpendicular to) the Z axis.

The metal material of the suspension wires 8 has electrical conductivity and good elasticity. Examples of this metal material include, for example, a copper alloy. Each of the suspension wires 8 has a circular shape in sectional view and straightly extends. The diameter of the suspension wire 8 is about 50 μm, and a support span by which the suspension wire 8 supports the movable unit 20 on the base 11 is about 3 mm.

As illustrated in FIG. 3, the movable unit 20 includes a support member (movable base) 21. The support member 21 is formed of a synthetic resin material.

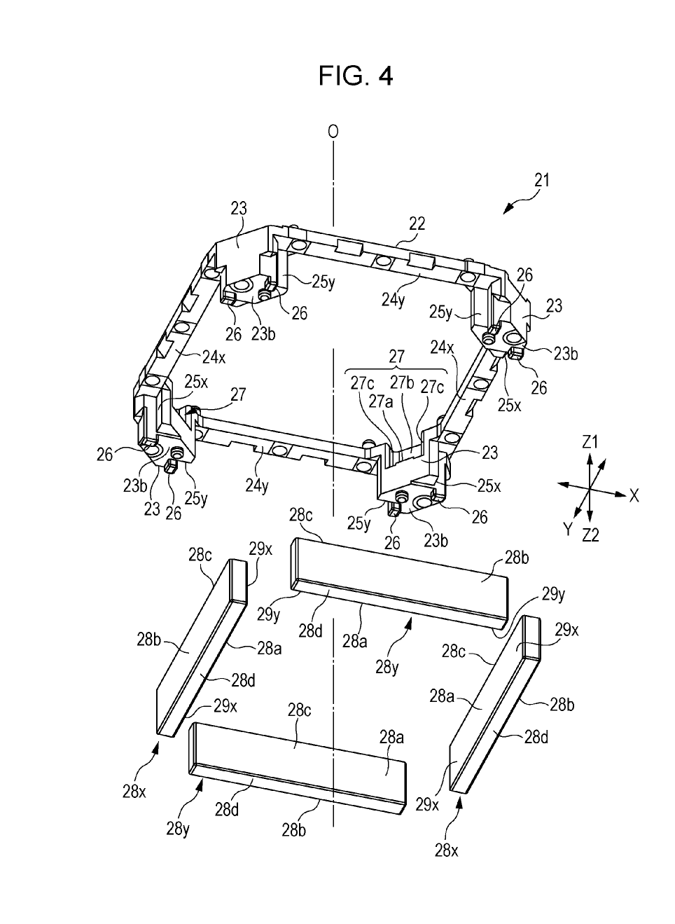

As illustrated in FIGS. 3 and 4, the support member 21 includes a frame 22 having a rectangular shape (substantially square shape) in plan view. Preferably, the support member includes four legs 23 extending along the optical axis. Four legs extend downward (Z2 direction) from four corners. The frame 22 and the legs 23 are integrally formed with one another. Magnet holding recesses (magnet holding spaces) 24y are formed between the legs 23 facing in the X direction on the lower side of the frame 22. Magnet holding recesses (magnet holding spaces) 24x are formed between the legs 23 facing in the Y direction on the lower side of the frame 22. The magnet holding recesses 24x and 24y are provided at four positions in total.

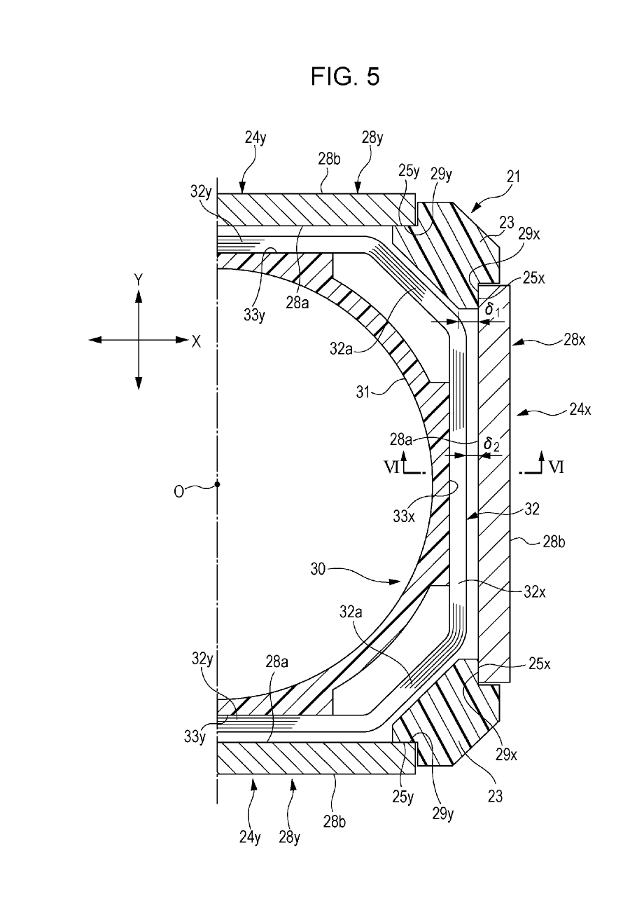

As illustrated in FIGS. 4 and 5, preferably, the legs 23 provided at four positions have respective X direction positioning portions 25x and respective Y direction positioning portions 25y. In a single leg 23, the X direction positioning portion 25x and the Y direction positioning portion 25y project from respective side portions, which are perpendicular to each other. The X direction positioning portions 25x are flat surfaces parallel to the Y-Z plane, and the Y direction positioning portions 25y are flat surfaces parallel to the X-Z plane. The X direction positioning portions 25x are formed in the side portions of the legs 23 separated from and facing each other in the Y direction in one and the other pairs of the legs 23 in the Y direction. Likewise, the Y direction positioning portions 25y are formed in the side portions of the legs 23 separated from and facing each other in the X direction in one and the other pairs of the legs 23 in the X direction.

As illustrated in FIG. 5, a pair of the X direction positioning portions 25x provided on both sides of a single magnet holding recess 24x are positioned in the same plane parallel to the Y-Z plane, and a pair of the Y direction positioning portions 25y provided on both sides of a single magnet holding recess 24y are positioned in the same plane parallel to the X-Z plane.

As illustrated in FIG. 4, preferably, a pair of reference surfaces 26 are provided on a lower end surface 23b, which faces the Z2 side, of each of the legs 23. The reference surfaces 26 are end surfaces of projections projecting downward from the lower end surface 23b. Two reference surfaces 26 are provided on the lower end surface 23b of a single leg 23. A single reference surface 26 is disposed at one end of the magnet holding recess 24x and a single reference surface 26 is disposed at another end of the magnet holding recess 24x. Also, a single reference surface 26 is disposed at one end of the magnet holding recess 24y and a single reference surface 26 is disposed at another end of the magnet holding recess 24y. These reference surfaces 26 are formed on lower portions of the support member 21 positioned on the base 11 side (Z2 side).

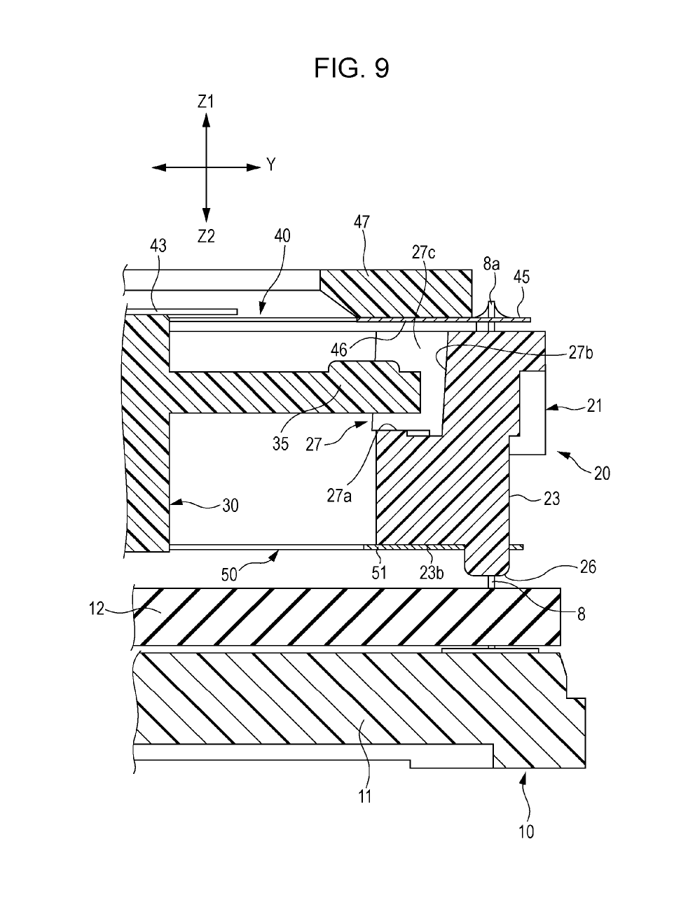

As illustrated in FIGS. 3, 4, 7, and 9, preferably, stopper recesses 27 are formed on the inner peripheral side of the legs 23 provided in the support member 21. The stopper recesses 27 are provided at four positions in total in the support member 21. Each of the stopper recess 27 opens at the top (Z1 side) and toward the center line O (inward). As illustrated in FIGS. 4 and 9, each of the stopper recesses 27 is defined by a lower stopper 27a and an optical-axis intersecting stopper 27b. The lower stopper 27a is a bottom portion positioned on the Z2 side. The optical-axis intersecting stopper 27b is a wall surface rising in the Z direction so as to face the center line O and face in a radial line direction (radial direction). Rotational stoppers 27c are a pair of wall surfaces facing each other in a rotational direction (circumferential direction) centered at the center line O.

Magnets 28x are disposed in the magnet holding recesses 24x formed in the support member 21, and magnets 28y are disposed in the magnet holding recesses 24y formed in the support member 21. Preferably, four magnets 28x and 28y have the same plate shape (flat plate shape). Four magnets 28x and 28y have the same dimensions. Each of the magnets 28x and 28y has a rectangular inner facing portion 28a and an outer surface portion 28b having a rectangular shape as the inner facing portion 28a. The inner facing portion 28a faces inward (center line O side) and has the long side in a direction perpendicular to the center line O (optical axis). The outer surface portion 28b faces outward. An upper end surface 28c extending along the long side of the rectangular shape faces upward (Z1 direction) and a lower end surface 28d faces downward (Z2 direction).

The inner facing portion 28a and the outer surface portion 28b of each of the magnets 28x and 28y are magnetized so that the inner facing portion 28a and the outer surface portion 28b have respective magnetic poles opposite to each other. For example, the inner facing portion 28a has the N pole and the outer surface portion 28b has the S pole.

As illustrated in FIG. 5, preferably, each of the magnets 28x is positioned by bringing both end portions 29x of the inner facing portion 28a in the Y direction into contact with the X direction positioning portions 25x formed in the respective legs 23. Thus, the distances between the center line O and the inner facing portions 28a of a pair of the magnets 28x facing each other in the X direction can be equalized. Preferably, each of the magnets 28y is positioned by bringing both end portions 29y of the inner facing portion 28a in the X direction into contact with the Y direction positioning portions 25y formed in the respective legs 23. Thus, the distances between the center line O and the inner facing portions 28a of a pair of the magnets 28y facing each other in the Y direction can be equalized.

Preferably, each of the magnets 28x and 28y is positioned so that the lower end surface 28d thereof is flush with the reference surfaces 26 projecting from the lower end surfaces 23b of the legs 23. This can be achieved by aligning the lower end surfaces 28d of the magnets 28x and 28y and the reference surfaces 26 with the same reference flat plane.

The magnets 28x and 28y are bonded to the support member 21 by an adhesive in a state in which each of the magnets 28x is in contact with the corresponding X direction positioning portions 25x so as to be positioned and each of the magnets 28y is in contact with the corresponding Y direction positioning portions 25y so as to be positioned, and furthermore, the magnets 28x and 28y are positioned so that the lower end surfaces 28d thereof are flush with the reference surfaces 26.

The lens holder 30 is provided inside the support member 21 of the movable unit 20. The lens holder 30 is formed of synthetic resin and has a cylindrical shape having a circular holding hole 31 penetrating therethrough in the up-down direction (Z direction) at the center thereof. The lens for picking up images is held in a lens barrel. The lens barrel that holds the lens (lens body) is attachable to the holding hole 31. Accordingly, a thread groove used to attach the lens body is provided for the holding hole 31 of the lens holder 30. It is noted that illustration of the lens and the lens barrel is omitted from the embodiment.

The central axis of the lens holder 30 is coincident with the optical axis of the lens held by this lens holder 30 and the center line O.

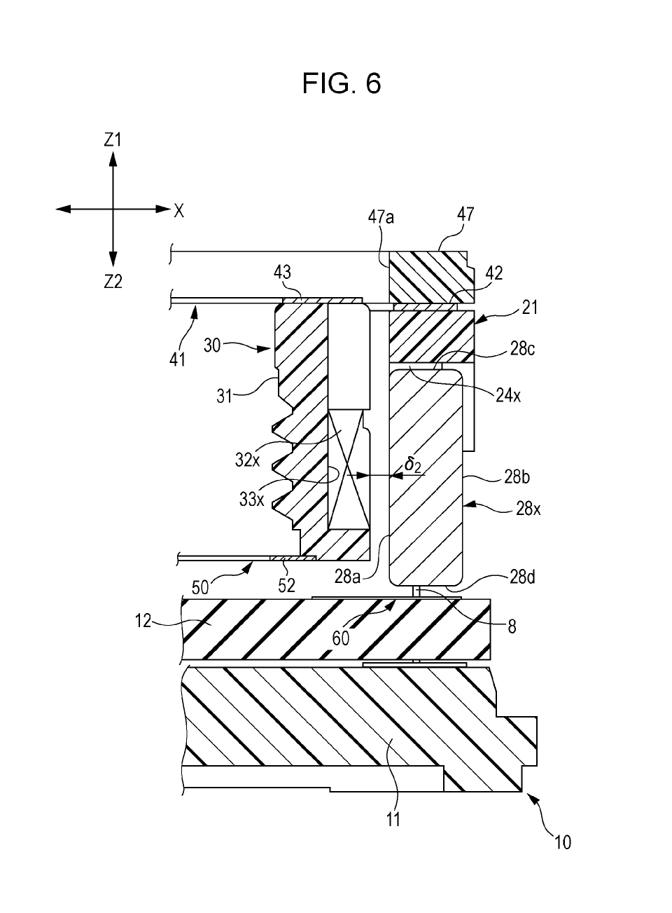

As illustrated in, for example, FIGS. 3 and 6, a first plate spring 40 is secured on the upper side of the support member 21 and a second plate spring 50 is secured on the lower side of the legs 23 of the support member 21. The lens holder 30 is supported by the first plate spring 40 and the second plate spring 50 such that the lens holder 30 is movable along the center line O (along the optical axis) relative to the support member 21 in the support member 21.

As illustrated in FIG. 3, the first plate spring 40 includes two divided spring portions 41 that are independent of each other. The divided spring portions 41 are formed of an electrically conductive metal plate having spring properties such as a copper alloy or a phosphor bronze plate. Each of the divided spring portions 41 has an outer securing portion 42, an inner securing portion 43, and a spring deformation portion 44 that connects the outer securing portion 42 and the inner securing portion 43 to each other. The inner securing portion 43, the outer securing portion 42, and the spring deformation portion 44 are integrally formed with one another. Securing holes 42a are open in the outer securing portion 42, and securing holes 43a are open in the inner securing portion 43.

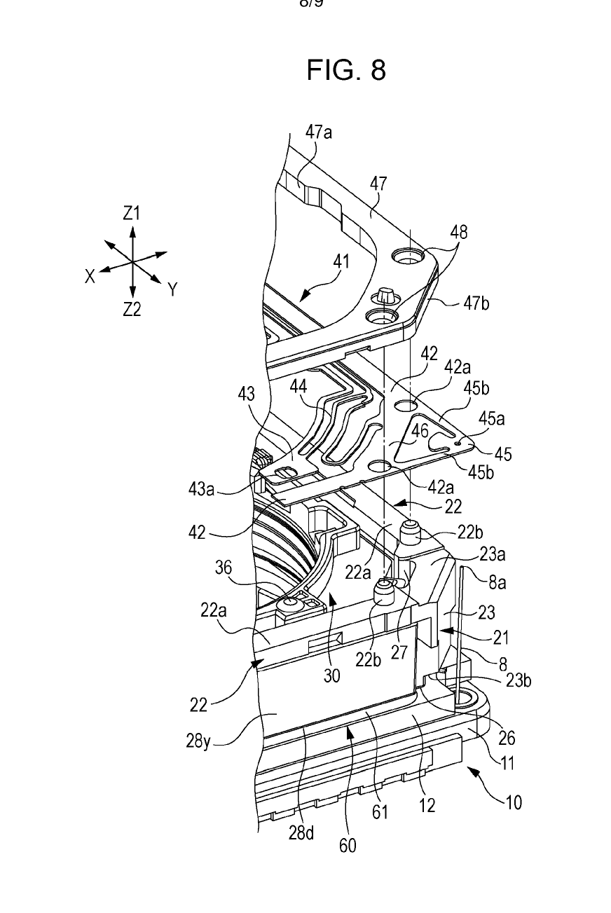

As illustrated in FIG. 8, wire connecting portions 45 are provided at corners of each of the divided spring portions 41. The wire connecting portions 45 have connecting holes 45a that are open therein. Elastic arms 45b are provided between the wire connecting portions 45 and the outer securing portion 42. The elastic arms 45b, the outer securing portion 42, and the wire connecting portions 45 are integrally formed with one another.

As illustrated in FIG. 8, securing projections 22b are integrally formed with the frame 22 of the support member 21 on an upper surface 22a of the frame 22. A step is formed between the upper surface 22a of the frame 22 and an upper surface 23a of each of the legs 23, thereby the upper surface 23a of the leg 23 is formed at a lower position further to the Z2 side than the upper surface 22a of the frame 22 by the height of a single step.

As illustrated in FIGS. 3 and 8, a pressing member 47 formed of synthetic resin is secured on the first plate spring 40 in the movable unit 20. The pressing member 47 has a quadrangle (rectangular) frame shape and has an opening 47a at its center. The pressing member 47 has corners, and securing holes 48 are open at two positions of each of the corners.

The outer securing portion 42 formed in each of the divided spring portions 41 of the first plate spring 40 is disposed on the upper surface 22a of the frame 22 of the support member 21, and the pressing member 47 is disposed on top of the outer securing portion 42. The securing projections 22b projecting from the upper surface 22a of the frame 22 of the support member 21 are inserted into the respective securing holes 42a formed in the outer securing portion 42 of the divided spring portion 41, and further inserted into the securing holes 48 of the pressing member 47. Top ends of the securing projections 22b are secured in the securing holes 48 by cold swaging, hot swaging, or bonding. As a result, the outer securing portion 42 of the divided spring portion 41 is interposed and secured between the support member 21 and the pressing member 47.

As illustrated in FIGS. 3 and 8, securing projections 36 are integrally formed with the lens holder 30 on an upper portion of the lens holder 30. The inner securing portion 43 provided in each of the divided spring portions 41 is disposed on an upper surface of the lens holder 30. At this time, the securing projections 36 are inserted into the securing holes 43a and secured by cold swaging or hot swaging. That is, in the upper portion of the lens holder 30, the first plate spring 40 (divided spring portions 41) is provided so as to connect the lens holder 30 and the support member 21 to each other. Thus, the upper portion of the lens holder 30 is supported by the support member 21 through the first plate spring 40.

As illustrated in FIG. 8, an upper stopper 46 is formed between a pair of the securing holes 42a at each of the corners of each of the divided spring portions 41. When the outer securing portion 42 of the divided spring portion 41 is secured to the upper surface 22a of the frame 22 of the support member 21, an upper opening of the stopper recess 27 formed on the inner peripheral side of a corresponding one of the legs 23 of the support member 21 is closed by the upper stopper 46.

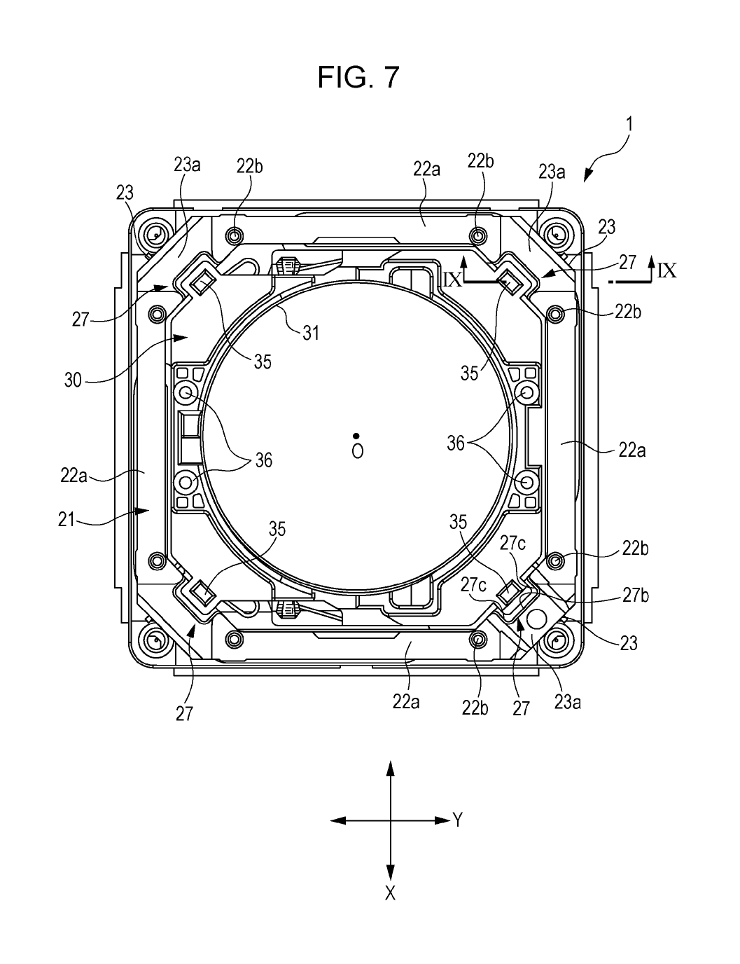

As illustrated in FIGS. 3 and 7, preferably, regulation projections 35 are integrally formed with the lens holder 30 at four corners of the lens holder 30. In this case, each of the regulation projections 35 radially projects outward (more specifically, in a direction separating from the center line O). Preferably, when the lens holder 30 is disposed inside the support member 21 as illustrated in FIGS. 7 and 9, the regulation projections 35 are inserted into the respective stopper recesses 27 formed in the support member 21.

As illustrated in FIG. 9, upward and downward movements of each of the regulation projections 35 are regulated by the lower stopper 27a being a bottom of a corresponding one of the stopper recesses 27 and by a corresponding one of the upper stoppers 46 being part of the divided spring portions 41.

When the outer securing portion 42 of each of the divided spring portions 41 illustrated in FIG. 8 is secured to the upper surface 22a of the frame 22 of the support member 21, the elastic arms 45b and the wire connecting portions 45 of the divided spring portion 41 project further to the outside than corner side surfaces 47b of the pressing member 47. Furthermore, the elastic arms 45b and the wire connecting portions 45 are positioned on the upper surfaces 23a of the legs 23. Here, the upper surfaces 23a are formed at lower positions than the upper surfaces 22a of the frame 22 by the height of a single step. Thus, there is a gap between the upper surface 23a of each of the legs 23 and the corresponding elastic arms 45b and the corresponding wire connecting portion 45. This allows the elastic arms 45b to be elastically deformed in the up-down direction.

The upper end 8a of each of the suspension wires 8 secured to the base 11 is inserted through the connecting hole 45a formed in a corresponding one of the wire connecting portions 45 and secured to the wire connecting portion 45 by soldering. This allows the movable unit 20 including the support member 21, the pressing member 47, and the lens holder 30 to move on the base 11 in directions intersecting the center line O.

As illustrated in FIG. 3, the second plate spring 50 is formed of a metal plate having spring properties as a single member. The second plate spring 50 has outer securing portions 51, an inner securing portion 52, and a spring deformation portions 53 that connect the outer securing portions 51 and the inner securing portion 52 to one another. The outer securing portions 51, the inner securing portion 52, and the spring deformation portions 53 are integrally formed with one another.

The outer securing portions 51 of the second plate spring 50 are secured by swaging or the like to the respective lower end surfaces (lower end surfaces facing the Z2 side) 23b of the legs 23 that extend downward at four positions of the support member 21. As illustrated in FIG. 6, the inner securing portion 52 is secured to a lower surface of the lens holder 30 by an adhesive or the like. That is, in a lower portion of the lens holder 30, the second plate spring 50 is provided so as to connect the lens holder 30 and the support member 21 to each other.

The upper portion and the lower portion of the lens holder 30 are supported by the first plate spring 40 and the second plate spring 50, respectively. This allows the lens holder 30 to move upward and downward inside the support member 21 in a direction in which the center line O extends (optical axis direction of the lens).

As illustrated in FIGS. 3, 5, and 6, an axial drive coil (focus coil) 32 is wound so as to surround the cylindrical lens holder 30 on an outer circumference of the lens holder 30. The axial drive coil 32 is formed by winding a conductor in a direction rotating about the center line O. A control current applied to the axial drive coil 32 flows in a direction intersecting the center line O.

One end of the conductor that forms the axial drive coil 32 is solder connected to one of the divided spring portions 41 of the first plate spring 40, and the other end of the conductor is solder connected to the other divided spring portion 41. The control current is applied to the axial drive coil 32 through the suspension wires 8 and the divided spring portions 41.

The shape of the axial drive coil 32 in plan view is illustrated in FIG. 5. Preferably, the axial drive coil 32 includes magnet facing portions 32x, magnet facing portions 32y, and leg facing portions 32a. The magnet facing portions 32x face the inner facing portions 28a of the respective magnets 28x. The magnet facing portions 32y face the inner facing portion 28a of the respective magnets 28y. The leg facing portions 32a face the respective legs 23. Preferably, the axial drive coil 32 has an octagonal shape in plan view.

As illustrated in FIG. 5, outer side surfaces of the lens holder 30 facing the X direction are coil support surfaces 33x extending parallel to the Y-Z plane, and outer side surfaces of the lens holder 30 facing the Y direction are coil support surfaces 33y extending parallel to the X-Z plane. Inner side portions of the magnet facing portions 32x of the axial drive coil 32 are in close contact with and supported by the coil support surfaces 33x, and inner side portions of the magnet facing portions 32y are in close contact with and supported by the coil support surfaces 33y. Inner side portions of the leg facing portions 32a are kept separated from an outer circumferential surface of the lens holder 30.

As illustrated also in FIG. 6, preferably, outer side surfaces of the magnet facing portions 32x of the axial drive coil 32 are flat portions parallel to the Y-Z plane. These flat portions face and are parallel to the inner facing portions 28a of the magnets 28x. Likewise, preferably, outer side surfaces of the magnet facing portions 32y of the axial drive coil 32 are flat portions parallel to the X-Z plane. These flat portions face and are parallel to the inner facing portions 28a of the magnets 28y.

As illustrated in FIG. 5, in the support member 21, the X direction positioning portions 25x support both side portions of each of the magnets 28x in the Y direction. This allows the magnet facing portions 32x of the axial drive coil 32 to be located close to the inner facing portions 28a of the magnets 28x. That is, a facing distance 62 between the magnet facing portions 32x of the axial drive coil 32 and the inner facing portions 28a of the magnets 28x can be smaller than a dimension 61 by which the legs 23 project inward from the respective end portions 29x of the magnets 28x.

Furthermore, the flat portions of the magnet facing portions 32x of the axial drive coil 32 can have sufficiently larger lengths than flat portions of the leg facing portions 32a in the Y direction, and the magnet facing portions 32x and magnets 28x can be located close to each other and face each other through a large range with the small facing distance 62 therebetween. Furthermore, the inner facing portions 28a of the magnets 28x are in contact with the X direction positioning portions 25x so as to be positioned. This allows the facing distance 62 of FIGS. 5 and 6 to be highly accurately controlled.

The facing relationships between the magnet facing portions 32y and the magnets 28y are the same as the facing relationships between the magnet facing portions 32x and the magnets 28x.

According to the present embodiment, the magnet facing portions 32x and 32y of the axial drive coil 32 and the magnets 28x and 28y are included in an axial-direction drive mechanism that moves the lens holder 30 in the optical axis direction.

As illustrated in FIGS. 2, 3, and 8, an insulating board 12 is secured on the base 11 of the base structure 10. Axis-intersecting drive coils 60 are provided at four positions of the insulating board 12. Thus, the axis-intersecting drive coils 60 are supported by the base 11. Each of the axis-intersecting drive coils 60 is formed of a thin film such as copper foil on a surface of the insulating board 12 or inside the insulating board 12. The axis-intersecting drive coils 60 is each formed to have a scroll pattern along a long flat surface and includes an outer electromagnetic operating portion 61 disposed at a position separated from the center line O and an inner electromagnetic operating portion 62 disposed at a position close to the center line O. The axis-intersecting drive coils 60 may be provided both on the surface (upper surface) of the insulating board 12 and inside the insulating board 12. In this case, the electrically conductive scroll patterns of the axis-intersecting drive coils 60 on the surface (upper surface) and inside the insulating board 12 are connected to one another through through holes.

When the movable unit 20 is supported by the suspension wires 8 secured to the base 11, the lower end surfaces 28d of four magnets 28x and 28y secured to the support member 21 face from above the respective outer electromagnetic operating portions 61 of the axis-intersecting drive coils 60 as illustrated in FIGS. 2 and 8. Preferably, the axis-intersecting drive coils 60 and the magnets 28x and 28y are included in an axis-intersecting drive mechanism that moves the movable unit 20 in directions intersecting the center line O. In this case, the axis-intersecting drive mechanism is disposed on the upper side (Z1 side) of the base 11.

Although it is not illustrated, position detecting elements are provided in the insulating board 12. The position detecting elements are Hall elements or magnetoresistance effect elements. The position detecting elements are provided at at least two positions. The position detecting elements face the lower end surfaces 28d of the magnets 28x at at least one position and face the lower end surfaces 28d of the magnets 28y at the other position or positions.

As illustrated in FIG. 1, the cover 2 that covers the movable unit 20 is provided in the lens drive device 1. The cover 2 is formed of, for example, non-magnetic stainless steel. The cover 2 has a cubic shape having four side plates 2a and a top plate 2b positioned on the upper side (in the Z1 direction) of four side plates 2a. The side plates 2a and the top plate 2b are integrally formed with one another. The top plate 2b has a substantially circular window 2c that allows light to pass therethrough. Lower edge portions of the side plates 2a are brought into contact with an upper surface of the base 11 provided in the base structure 10, and the base 11 and the cover 2 are secured to each other by, for example, an adhesive.

Next, operation of the lens drive device 1 having the above-described structure is described.

The lens drive device 1 has separate energizing paths from the suspension wires 8 through the divided spring portions 41 of the first plate spring 40 to both the end portions of the conductor of the axial drive coil 32. The control current is applied through the energizing paths to the axial drive coil 32.

When the control current is applied to the axial drive coil 32 included in the axial-direction drive mechanism, the lens holder 30 is moved along the center line O in the movable unit 20 due to the current flowing through the magnet facing portions 32x and 32y of the axial drive coil 32 and magnetic fields emitted from the magnets 28x and 28y. The imaging device is provided on the rear side (Z2 direction) of the base structure 10. The focus on the imaging device is adjusted by a movement of the lens holder 30 along the center line O.

Furthermore, when control currents are applied to the axis-intersecting drive coils 60 of the axis-intersecting drive mechanism, the movable unit 20 supported by the suspension wires 8 is driven in directions intersecting the center line O mainly due to the currents flowing through the outer electromagnetic operating portions 61 and a magnetic fluxes reaching the outer surface portions 28b from the inner facing portions 28a on the lower sides of the magnets. The amount of the movement of the movable unit 20 in a direction intersecting the center line O is detected by the position detecting elements provided in the insulating board 12. This detection output is fed back so as to control the amounts of the control currents applied to the axis-intersecting drive coils 60. Compensation for camera shake during picking up a picture and the like are performed by this control operation.

As illustrated in FIG. 5, in the movable unit 20 of the lens drive device 1, each of the magnets 28x is positioned by bringing both the end portions 29x in the longitudinal direction (Y direction which is a direction intersecting the optical axis) of a corresponding one of the inner facing portions 28a into contact with the X direction positioning portions 25x of the support member 21, and each of the magnets 28y is positioned by bringing both the end portions 29y in the longitudinal direction (X direction which is a direction intersecting the optical axis) of a corresponding one of the inner facing portions 28a into contact with the Y direction positioning portions 25y of the support member 21.

Since the magnets 28x and 28y are secured to the support member 21 while using the inner facing portions 28a as the positioning references, even when there is a variation in thickness among the magnets 28x and 28y, the facing distance 62 between each of the magnets 28x and 28y and a corresponding one of the magnet facing portions 32x and 32y of the axial drive coil 32 is not affected. Accordingly, it is not required that the thicknesses of the magnets 28x and 28y be unnecessarily highly accurately controlled. This can reduce the manufacturing cost of the magnets.

Since the variation in the facing distance 62 between the axial drive coil 32 and the magnets 28x and 28y provided at four positions can be reduced, drive forces applied from the magnets to the respective magnet facing portions 32x and 32y of the axial drive coil 32 can be equalized. As a result, the orientation of the lens holder 30 can be stabilized without being excessively inclined in the movable unit 20 while being moved in a direction along the optical axis.

Furthermore, due to elastic deformation of the spring deformation portions 44 of the first plate spring 40 and elastic deformation of the spring deformation portions 53 of the second plate spring 50, the lens holder 30 may move in directions intersecting the center line O inside the support member 21. Even in such a case, as illustrated in FIGS. 7 and 9, the regulation projections 35 formed in the lens holder 30 is brought into contact with the optical-axis intersecting stoppers 27b of the stopper recesses 27 formed in the support member 21, thereby the movement of the lens holder 30 is regulated. Also with this feature, a significantly large change in the facing distance 62 between the magnets and the axial drive coil does not occur during the drive of the lens holder 30, and accordingly, the orientation of the lens holder 30 can be stabilized while being moved by the axial-direction drive mechanism in the optical axis direction.

As illustrated in FIG. 5, the flat portions of the magnet facing portions 32x and 32y of the axial drive coil 32 face the inner facing portions 28a of the magnets through large lengths. In addition, the facing distance 62 can be reduced and the variation in the facing distance 62 is reduced. This allows the lens holder 30 to be efficiently and stably operated with the axial-direction drive mechanism.

Furthermore, each of the magnets 28x and 28y is secured to the support member 21 so that the lower end surface 28d thereof is flush with the reference surfaces 26 provided on the lower end surfaces 23b of the legs 23. This can equalize the gaps between the lower end surfaces 28d of all the magnets and the axis-intersecting drive coils 60. Thus, the movable unit 20 can be driven in directions intersecting the optical axis in a well-balanced manner with the axis-intersecting drive mechanism.

FIGS. 6 and 9 illustrate the position of the lens holder 30 when the axial drive coil 32 is not energized. When the axial drive coil 32 is energized, the lens holder 30 is moved in the Z1 direction or the Z2 direction. During this movement, the regulation projections 35 of FIG. 9 are not brought into contact with either the lower stoppers 27a or the upper stoppers 46 in the design.

However, the regulation projections 35 are brought into contact with the lower stoppers 27a or the upper stoppers 46 in the following cases, so that an excessive movement of the lens holder 30 can be regulated: in the case where the lens holder 30 moves in the optical axis direction by a distance larger than a normal distance when an abnormally large amount of current flows through the axial drive coil 32; or in the case where the lens holder 30 moves in the optical axis direction due to a shock from the outside. This can prevent excessively large deforming forces from acting on the first plate spring 40 and the second plate spring 50.

The upper stoppers 46 are parts of the first plate spring 40 and the pressing members 47 are superposed on upper surfaces of the upper stoppers 46. Thus, although the first plate spring 40 is a thin member, a stopping function is reliably provided. Accordingly, it can be said that also the pressing members 47 are parts of upper stopper portions.

Furthermore, the regulation projections 35 provided in the lens holder 30 are brought into contact with the optical-axis intersecting stoppers 27b of the stopper recesses 27 in the following situation so as to regulate the movement of the lens holder 30: when the spring deformation portions 44 of the first plate spring 40 and the spring deformation portions 53 of the second plate spring 50 are deformed due to a large acceleration acting on the movable unit 20 in a direction intersecting the center line O, and accordingly, the lens holder 30 is subjected to a force that can largely move the lens holder 30 in the direction intersecting the optical axis in the movable unit 20. Furthermore, when the lens holder 30 is subjected to a force that can rotate the lens holder 30 about the center line O, this rotational movement is regulated by bringing the regulation projections 35 into contact with the rotational stoppers 27c of the stopper recesses 27.

This can prevent excessively large deforming forces from acting on the first plate spring 40 and the second plate spring 50.

The stopper recesses 27 are formed in the support member 21. Thus, even when the support member 21 moves in a direction intersecting the center line O due to deformation of the suspension wires 8, the relative positional relationships between the regulation projections 35 provided in the lens holder 30 and the stoppers 27a, 27b, 27c, and 46 do not change. Thus, regardless of whether or not the support member 21 moves in directions intersecting the center line O, the movement of the lens holder 30 in the movable unit 20 can be constantly appropriately regulated.

What is claimed is:

1. A lens drive device comprising:
a support member;
a lens holder configured to hold a lens body therein;
a plate spring that is provided so as to connect the support member and the lens holder to each other and that supports the lens holder such that the lens holder is movable in an optical axis direction; and
an axial-direction drive mechanism that moves the lens holder relative to the support member in the optical axis direction,
wherein the axial-direction drive mechanism includes:
an axial drive coil that is supported by the lens holder and that is wound so as to surround the lens holder, and
a magnet that is secured to the support member and that faces the axial drive coil, and
wherein the support member includes at least one positioning portion that is in contact with an inner facing portion of the magnet facing a lens holder side so as to position the magnet.

2. The lens drive device according to claim 1,
wherein the at least one positioning portion includes a plurality of positioning portions,
wherein the magnet has a plate shape, the support member includes a plurality of legs extending along the optical axis, and the magnet is disposed between the plurality of legs,
wherein, in each of the plurality of legs, a corresponding one of the plurality of positioning portions is formed in a side portion facing a side portion of another of the plurality of legs, and
wherein parts of the inner facing portion of the magnet positioned at both ends in a direction intersecting the optical axis are in contact with the plurality of positioning portions.

3. The lens drive device according to claim 2,
wherein the axial drive coil includes:
a magnet facing portion that faces the magnet, and
a plurality of leg facing portions that face the plurality of legs, and
wherein the magnet facing portion has a flat portion disposed face-to-face with the magnet.

4. The lens drive device according to claim 3,
wherein a shape into which the axial drive coil is wound is an octagonal shape when seen from above along the optical axis.

5. The lens drive device according to claim 1,
wherein the support member is supported by a suspension wire secured to a base such that the support member is movable in a direction intersecting the optical axis, and
wherein the lens drive device includes an axis-intersecting drive mechanism that is disposed on an upper side of the base and that moves the support member in the direction intersecting the optical axis.

6. The lens drive device according to claim 5,
wherein the axis-intersecting drive mechanism includes an axis-intersecting drive coil that is supported by the base and that faces a lower end surface of the magnet,
wherein a reference surface is formed on a lower portion of the support member positioned on a base side of the support member, and
wherein the magnet is secured to the support member so that the lower end surface of the magnet is flush with the reference surface.

7. The lens drive device according to claim 1,
wherein the lens holder includes a regulation projection that projects in a direction separating from the optical axis and that is integrally formed with the lens holder, and
wherein the regulation projection faces the support member so as to regulate a movement of the lens holder relative to the support member in a direction intersecting the optical axis.

8. The lens drive device according to claim 7,
wherein the support member has a stopper recess into which the regulation projection is insertable, and
wherein the regulation projection faces the support member in the stopper recess.
